(19) United States
(12) Patent Application Publication
(10) Pub. No.: US 2017/0132544 A1
(43) Pub. Date: May 11, 2017

(54) METHOD AND SYSTEM FOR STOCHASTIC OPTIMIZATION OF PUBLIC TRANSPORT SCHEDULES

(71) Applicant: Xerox Corporation, Norwalk, CT (US)

(72) Inventors: Sofia Zaourar Michel, Grenoble (FR); Boris Chidlovskii, Meylan (FR)

(73) Assignee: Xerox Corporation

(21) Appl. No.: 14/936,917

(22) Filed: Nov. 10, 2015

(51) Int. Cl. G06Q 10/06; G06Q 50/30

(52) U.S. Cl. CPC G06Q 10/06313; G06Q 50/30

(57) ABSTRACT

Methods, systems, and processor-readable media for the stochastic optimization of public transport schedules. A real-world collection of transit instances can be derived from a transport system and fed as input to a two-stage stochastic program. A schedule offset can be relaxed in the two-stage stochastic program to allow the two-stage stochastic program to operate according to the real-world collection of transit instances. An optimized transport schedule can then be derived from the two-stage stochastic program for use by the transport system based on the schedule offset and the real-world collection of transit instances.

### TECHNICAL FIELD

Embodiments are generally related to multi-modality transportation systems. Embodiments further relate to the stochastic optimization of public transport schedules in the context of transportation systems.

### BACKGROUND

Despite a steady growth and sophistication of public transport systems, transfer waiting time remains one of their major weaknesses. For example, on average in the United Kingdom, 23% of travel time is lost in connections for trips involving more than one mode. Studies have shown that out-of-vehicle times are more annoying for passengers than in-vehicle times, and transfer waiting times are even more irritating since they cannot be managed by passengers.

Reducing the transfer waiting time can be addressed by a better scheduling of public transport services. Over the last two decades, numerous studies have focused on schedule synchronization, i.e., the design of schedules that minimize the delay caused by transfers. An important limitation of the standard operations research approaches is that the parameters of the problem are supposed to be known. However, the number of passengers making a given connection as well as the actual arrival and departure times of the vehicles at the stops is by nature non-deterministic. Only recently, some approaches that take into account the uncertainty of these parameters have been proposed.

A deterministic program to optimize a single route was then extended toward a stochastic method. This program used journey planner queries and results in order to quantify the transfer costs citywide. This in turn led to a model that determines changes in a schedule, defined by the offset, such that globally there is a decrease in the expected waiting time. This resulted in a two-stage stochastic program that re-optimizes multi-modal (multi-modality) transit schedules. The model works by offsetting the schedule such that the expected value of waiting times at all transfer points in the system is minimized. Transfer volumes of users across space and time are aggregated based on the results of queries that users make to a journey planner and are known only probabilistically.

### BRIEF SUMMARY

The following summary is provided to facilitate the understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved multi-modality transport system.

It is another aspect of the disclosed embodiments to provide for the stochastic optimization of public transport schedules in the context of transportation systems.

The aforementioned aspects and other objectives and advantages can now be achieved as described herein. Methods, systems, and processor-readable media are disclosed for the stochastic optimization of public transport schedules. A real-world collection of transit instances can be derived from a transport system and fed as input to a two-stage stochastic program. An optimized transport schedule can then be derived from the two-stage stochastic program for use by the transport system.

In an example embodiment, a method can be implemented for minimizing waiting times of passengers during transfers in a transport system. Such a method can include steps or operations for incorporating a real-world collection of transit instances derived from a transport system into a stochastic optimization module; relaxing a flexible schedule offset in said stochastic optimization module to allow said stochastic optimization module to operate according to said real-world collection of transit instances; and deriving an optimized transport schedule from the stochastic optimization module for use by the transport system based on the flexible schedule offset and the real-world collection of transit instances in order to minimize the waiting times of passengers during transfers via the transport system.

Various embodiments may be implemented via a device or system comprising a processor and a memory. The processor and memory can be configured to perform one or more of the above described method operations. Other embodiments may be implemented via a computer readable storage medium or processor-readable media having computer program instructions stored thereon that are arranged to perform one or more of the above described method operations.

These and other features and advantages of the disclosed embodiments will he presented in more detail in the following specification and the accompanying figures, which illustrate, by way of example, the principles of the disclosed example embodiments.

### BRIEF DESCRIPTION OF THE DRAWINGS

The accompanying figures, in which like reference numerals refer to identical or functionally similar elements throughout the separate views and which are incorporated in and form a part of the specification, further illustrate the example embodiments and, together with the detailed description, serve to explain the principles of the disclosed embodiments.

FIG. 1 illustrates a schematic diagram of an example embodiment of an environment in which a system for selective screen sharing may operate;

FIG. 2 illustrates a schematic diagram depicting an example embodiment of a client device for providing a selective screen sharing application; and

FIG. 3 illustrates a high-level flow chart of operations depicting logical operational steps of a method for the optimization of public transport schedules, in accordance with an example embodiment.

### DETAILED DESCRIPTION

Subject matter will now be described more fully hereinafter with reference to the accompanying drawings, which form a part hereof, and which show, by way of illustration. specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood, at least in part, from usage in context. For example, terms, such as “and”, “or”, or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a”, “an”, or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Example embodiments are disclosed, which take a data-driven approach to the schedule synchronization of a multi-modal transportation system. Note that as utilized herein the term multi-modal or multi-modality in the context of a transportation system (e.g., a public transport system) refers to a transportation system that considers various modes (e.g., walking, cycling, automobile, public transit such as subways, bus routes, trains, etc.) and connections among modes.

Using a real-world collection of transit instances in a public transport system, a new model can be implemented to alter existing schedules in order to minimize the waiting times of passengers during transfers. This approach is a generalization of previous data-driven works: it is closer to the real use of the network because it is based on real passenger trips instead of queries to a journey planner; and it is more general and realistic because we get rid of certain restrictive assumptions. Example embodiments can model the problem as a two-stage stochastic linear program with mixed-integer variables. The disclosed approach when implemented reduces significantly the expected transfer waiting times.

As will be discussed in greater detail herein, example embodiments address the problem of schedule (re)-optimization in a public multi-modal transport system. Unlike prior approaches that utilize trip planner queries and results, the disclosed approach copes with real transit events extracted from smart card data deployed in a public scheduled-based system. Such data represents a rich source of information on how the transit system works and how people travel.

Using real transit data, the problem of minimizing the expected waiting time is revised. Analysis of the real transit events unveil some limitations of previous solutions, due to a mismatch between real transit events and the ones inferred by a trip planner from the theoretical schedule. Indeed, due to the stochastic character of the transport system, multiple small and large fluctuations in service adherence instantiate transit scenarios, which are simply impossible in theory; moreover, their frequency and volumes vary a lot in different stops and times of the day. Direct application of the two-stage stochastic program to the real transit data makes the feasibility domain of the optimization problem too small and thus yields no significant improvement.

Indeed, in reality users are faced with frequent twists and changes in, for example, a bus arrival order. Therefore, real data contains transfer instances that would be deemed impossible considering only the theoretical schedule. The simple offset within the available schedule, which disregards the frequent changes in the bus transfer order, renders the prior solution too limited. Thus, the disclosed embodiments fix this mismatch by an important generalization of the two-stage stochastic model that allows transits to happen exactly in the way they occur in the real world. Example embodiments are aimed at analyzing massive amounts of commuter data and rendering such data easy for transport operators to utilize and better understand and predict their needs. Such example embodiments can be implemented in the context of services and solutions for improving the transportation network and system, including schedule optimization.

The novelty of the disclosed embodiments is based on a number of factors. For example, the disclosed approach addresses the problem of transit schedule re-optimization in a multi-modality transportation system. Example embodiments also can utilize a collection of available individual transit trips as instances of transfer. Additionally, the two-stage stochastic program is revised for transit schedule re-optimization. The disclosed embodiments are also not applied to theoretical schedules, which do not hold true in the real world. The problem is thus redefined for real transit events, and a more general solution can be implemented, which allows for the important generalization of the solution.

The generalization comes for the price of an increase in complexity: the generalized version we propose contains Boolean variables and potentially nonlinear constraints. However, we show how it can be linearized to obtain a mixed-integer linear program. Besides, because the problem of designing the schedules is strategic and do not need to be solved very frequently, it makes sense to spend more time to solve a more complex optimization problem that yields to better decisions. Embodiments have been tested and their efficiencies provide with respect to transit data collected in the public transport system of Nancy, France. A two-stage optimization model is described in greater detail, followed by data associated with an implemented system in Nancy, France. A transit trip collection is also discussed in greater detail herein, along with a report of an evaluation of the improved schedule.

The following data and notations are utilized herein:
[symbol] : set of routes. A route is a transit service serving a series of stops and is composed of a set of trips r={p₁, p₂, . . . , pₙ}.
[symbol] : set of trips, [symbol] :=∪_{r∈R}r.
[symbol] : set of nodes. A node can be an aggregation of several steps that allow connections from one another.
C: set of connections. A connection is a triplet (r, s, i)∈ [symbol] × [symbol] × [symbol] such that the node i is visited by both routes r and s.
Δᵣₛᵢ: average walking time to transfer from route r to route s at node i.
tₚᵢ: arrival (and departure) time of trip p at node i.
T_{pqi}: number of passengers transferring from trip p to q at stop i.
Tₚₛᵢ: number of passengers transferring from trip p to route s at stop i:

$${T}_{psi} := {\sum }_{q ∈ s} {T}_{pqi} .$$

The following assumptions are also made. First, when computing the number of transferring passengers T_{pqi} from the data, for a given trip q∈s from a connection (r,s,i), the only transfers that are considered are the ones from trips p∈r for which q is the first trip of s allowing the transfer, i.e., t_{qi}−tₚᵢ≧Δᵣₛᵢ and t_{(q-1)i}−tₚᵢ<Δᵣₛᵢ. Similarly, in the example embodiment (e.g., a model), the focus is on minimizing the waiting time from a trip p to the first possible one q. Second, it can be assumed that the probability distribution of the demand remains valid when the schedules are modified. More precisely, it can be further assumed that the probability distribution of the number of passengers Tₚₛᵢ transferring from a trip p to a route s at a node i does not change when tₚᵢ is shifted. This assumption is reasonable when there are not so many multiple transfers. For example, in the city of Nancy, France, only 13% of transferring passengers make multiple connections. A third assumption is that the capacities of the vehicles are always sufficient to embark all entering passengers. Fourth, to simplify the notations, the arrival and departure times of a given trip at a given stop can be considered to be the same. Hence, the variable or value t can be referred to as the arrival or departure time depending on the context of the application. The disclosed model can be easily modified to utilize different arrival and departure times.

The model that we propose is defined by its: (1) decision variables, (2) objective function, and (3) constraints. Each component is now described in detail. For simplicity, we start with the case where all the parameters of the problem are known.

Regarding the decision variables, three factors are considered: offset, transfer relevance, and the relevant waiting time as follows:
Offset. For every trip p∈ [symbol] , we introduce the continuous variable xₚ∈ [symbol] : the time shift of the schedule of trip p.
Note that we propose a unique offset per trip, i.e. the same offset will be applied at every stop.
Transfer relevance. For every pair of trips (p,q)∈r×s of a connection (r,s,i)∈C, we define the binary variable

$${y}_{pqi} = \{ \begin{matrix}1 & if the transfer from p to q at node i is relevant \\ 0 & otherwise\end{matrix} ,$$

Intuitively, we call a transfer relevant if passengers seeking to go from route r to s at node i and optimizing their journey would use this transfer. In other words, the transfer should be feasible and, if we fix p, q should be the first trip of s allowing the transfer. Symmetrically, for a fixed q, p should be the last trip of r that allows the transfer to q.
Relevant waiting time. For every pair of trips (p, q)∈r×s of a connection (r, s, i)∈C, we define the continuous variable

$${z}_{pqi} ∈ {+}_{} \text{:} \{ \begin{matrix}\begin{matrix}waiting time during \\ transfer from p to q at i\end{matrix} & if the transfer is relevant \\ 0 & otherwise\end{matrix} ,$$

### Objective

The objective to minimize is the total passengers waiting times during transfers. For a route r and a trip q∈s of a connection (r, s, i)∈C, by definition of the variable z_{pqi}, the passengers-minutes waiting time of transfers from r to q is

$${\sum }_{p ∈ r} {T}_{psi} {z}_{pqi} .$$

Therefore the objective is

$${\sum }_{( r , s , i ) ∈ C} {\sum }_{q ∈ s} {\sum }_{p ∈ r} {T}_{psi} {z}_{pqi} .$$

In accordance with an example embodiment, a minimal set of constraints is described below. Additional constraints may also be employed in practice and can be easily added to the model described herein.

First, the bounds on the time shifts can be expressed by the following constraint:

l_{b}≦xₚ≦uₚ (2)

Note that these bounds can be different depending on the service, the time of the day, etc.

The transfer feasibility constraint is now described. A transfer from p∈r to q∈s of a connection (r,s,i) is only feasible if there is enough time between the arrival time of p and the departure time of q at stop i as follows:

y_{pqi}((t_{qi}+x_{q})−(tₚᵢ+xₚ)−Δᵣₛᵢ)≧0.

This constraint imposes that for y_{pqi} to be 1, it is necessary that the difference between the arrival times of p and q is at least Δᵣₛᵢ. Note that the quadratic constraint can be linearized using the bounds from Equation (2) above, such the constraint is rewritten as follows:

(t_{qi}+x_{q})−(tₚᵢ+xₚ)≧y_{pqi}Δᵣₛᵢ+(1−y_{pqi})((t_{qi}+l_{q})−(tₚᵢ+uₚ)),

or equivalently as

x_{q}−xₚ≧y_{pqi}(Δᵣₛᵢ−t_{qi}+tₚᵢ)+(1−y_{pqi})(l_{q}−uₚ).

The waiting time for the transfer from trip p to q at stop i can be defined as follows:

z_{pqi}=((t_{qi}+x_{q})−(tₚᵢ+xₚ)−Δᵣₛᵢ)y_{pqi}

Because of the objective form, this constraint can be equivalent to

z_{pqi}≧((t_{qi}+x_{q})−(tₚᵢ+xₚ)−Δᵣₛᵢ)y_{pqi}

which can be linearized as follows:

z_{pqi}≧(x_{q}−xₚ)+y_{pqi}(t_{qi}−tₚᵢ−Δᵣₛᵢ)+(1−y_{pqi})(lₚ−u_{q}).

For a trip p∈r of a connection (r,s,i), such that there are passengers transferring from p to s (i.e., Tₚₛᵢ>0), the connection should be possible from p to at least one trip of s, i.e.,

$${\sum }_{q ∈ s} {y}_{pqi} \geq 1.$$

Possible additional constraints can include, for example, for a given route, the trips stay in the same order. In such a scenario, the variable d can denote the index of the departure node of a route r. The order conservation constraint can be:

t_{pd}+xₚ≦t_{qd}+x_{q}, ∀ₚ, q∈r, with t_{pd}<t_{qd}.

It can be useful to impose frequencies (denoted δ) for trips of a given route. This can be written as:

(t_{qd}+x_{q})−(t_{pd}+xₚ)≦δᵣ ∀p,q consecutive trips of ∈r.

The problem of minimizing transfer waiting times can be formulated as follows (Equation (3) below):

$$min {\sum }_{( r , s , i ) ∈ 𝒞} {\sum }_{( p , q ) ∈ r \times s} {T}_{psi} {z}_{pqi} \\ s . t . \\ \begin{matrix}{z}_{pqi} \geq ( {x}_{q} - {x}_{p} ) + {y}_{pqi} ( {t}_{qi} - {t}_{pi} - {Δ}_{rsi} ) + ( 1 - {y}_{pqi} ) ( {l}_{p} - {u}_{q} ) & ∀ ( p , q ) ∈ r \times s , ( r , s , i ) ∈ 𝒞 \\ {x}_{q} - {x}_{p} \geq {y}_{pqi} ( {Δ}_{rsi} - {t}_{qi} + {t}_{pi} ) + ( 1 - {y}_{pqi} ) ( {l}_{p} - {u}_{p} ) & ∀ ( p , q ) ∈ r \times s , ( r , s , i ) ∈ 𝒞 \\ {\sum }_{q ∈ s} {y}_{pqi} \geq 1 & ∀ p ∈ r , ( r , s , i ) ∈ C : {T}_{psi} > 0 \\ {l}_{b} \leq {x}_{p} \leq {u}_{p} & ∀ p ∈ \\ {x}_{p} ∈ & ∀ p ∈ \\ {y}_{pqi} ∈ \{ 0 , 1 \} & ∀ ( p , q ) ∈ r \times s , ( r , s , i ) ∈ 𝒞 \\ {z}_{pqi} ∈ {+}_{} & ∀ ( p , q ) ∈ r \times s , ( r , s , i ) ∈ 𝒞 .\end{matrix} \qquad ( 3 )$$

The above formulation constitutes a mixed-integer linear program. If Cₜᵣᵢₚₛ denotes the number of trip connections, the problem (3) contains 2 Cₜᵣᵢₚₛ binary variables, |P|+Cₜᵣᵢₚₛ continuous variables and O(Cₜᵣᵢₚₛ) constraints.
Cₜᵣᵢₚₛ binary variables (Nancy: less than 10,000),
   | [symbol] | continuous variables (Nancy: less than 2500),
[symbol] (Cₜᵣᵢₚₛ) constraints.

As explained previously herein, a public transport system is by nature stochastic and therefore the deterministic version is not realistic. In real-life, the arrival and departure times of the vehicles as well as the number of transferring passengers vary from day to day and are unknown at the moment of designing the schedules. However, we often have access to past data with the observed real schedules and transfers. We assume that a probability distribution governing these parameters is known or can be estimated from the observations.

Stochastic optimization can then be utilized to design the schedules. More precisely, we can design schedules (x decision variables) and then events that depend on the schedules, but also on some random events will happen (arrival/departure time of the vehicles and passengers willing to make transfers); let us denote by ξ this random variable. The passengers will then optimize their transfers according to the situation and that will result in a waiting time that we want to minimize.

Therefore, the problem of minimizing the transfer waiting times can be modeled as a two-stage stochastic problem where in the first stage problem consists in finding the schedules that minimize the expected waiting time over all possible realizations of the random parameters ξ:

$$\{ \begin{matrix}min & {ξ}_{} [ W ( x , ξ ) ] & \\ s . t . & {l}_{p} \leq {x}_{p} \leq {u}_{p} & ∀ p ∈\end{matrix} ,$$

Such that for a given realization of ξ, the waiting time is defined by the second stage sub problem:

$$\{ \begin{matrix}W ( x , ξ ) := {min}_{y , z} {\sum }_{( r , s , i ) ∈ 𝒞} {\sum }_{( p , q ) ∈ r \times s} {T}_{psi} ( ξ ) {z}_{pqi} & \\ s . t . {z}_{pqi} \geq ( {x}_{q} - {x}_{p} ) + {y}_{pqi} ( {t}_{qi} ( ξ ) - {t}_{pi} ( ξ ) - {Δ}_{rsi} ) + ( 1 - {y}_{pqi} ) ( {l}_{p} - {u}_{q} ) & ∀ ( p , q ) ∈ r \times s , ( r , s , i ) ∈ 𝒞 \\ {x}_{q} - {x}_{p} \geq {y}_{pqi} ( {Δ}_{rsi} - {t}_{qi} ( ξ ) + {t}_{pi} ( ξ ) ) + ( 1 - {y}_{pqi} ) ( {l}_{q} - {u}_{p} ) & ∀ ( p , q ) ∈ r \times s , ( r , s , i ) ∈ 𝒞 \\ {\sum }_{q ∈ s} {y}_{pqi} \geq 1 & ∀ p ∈ r , ( r , s , i ) ∈ C : {T}_{psi} ( ξ ) > 0 \\ {y}_{pqi} ∈ \{ 0 , 1 \} , {z}_{pqi} ∈ {+}_{} & ∀ ( p , q ) ∈ r \times s , ( r , s , i ) ∈ 𝒞 .\end{matrix}$$

In order to solve this two-stage stochastic problem numerically, a standard strategy is to assume that the random variable ξ has a finite number of realizations, called scenarios. Thus, if we suppose that ξ takes the values ξ₁, . . . , ξ_{K} with respective probabilities p₁, . . . p_{K} the first stage objective becomes:

$$\{ \begin{matrix}min & {\sum }_{k = 1}^{K} {p}_{k} W ( x , {ξ}_{k} ) & \\ s . t . & {l}_{p} \leq {x}_{p} \leq {u}_{p} & ∀ p ∈\end{matrix} .$$

The global problem is then still a mixed-integer linear program. Compared to the previous deterministic version, the problem now contains the same number of x variables, but the number of y and z variables as well as the number of constraints is roughly multiplied by the number of scenarios.

In order to decrease the size of the problem, we can restrict our model to certain alternatives. Specifically, if the historical data contains a transfer between trips p∈r and q∈s of a connection (r,s,i)∈C, we only allow the disclosed model to find transfers between p and a window of trips around q, rather than between p and any trip of s. It can be a “time window” (e.g., we consider the trips of s that are at most 20 minutes before or after q) or a “trip window” (e.g., we consider at most 2 trips before q and two after).

In the previous formulation, the constraint regarding the necessity of transfers (Σ_{q}y_{pqi}≧1) depends on the scenario: it is present in the second stage sub problem only if passengers made a transfer from p to s in the scenario (Tₚₛᵢ(ξ)>0). We could make this constraint independent of the scenarios, if at least one scenario contains the transfer from p to s, then we add this constraint in every second-stage sub problem. This would restrain the feasible space of the schedules and therefore potentially increase the optimal expected waiting time, but could also make the solution more robust.

In an example embodiment, preliminary numerical results were determined in order to validate the disclosed approach. For example, transit data derived from the city of Nancy, France (extracted from e-card validation collection) were used in an example validation embodiment. To make the problem size reasonable for the proof-of-concept prototype, only the routes 00 (tram) and 31 (bus) were considered, which are the most regular and loaded routes. To generate such example scenarios, an assumption can be made that for similar weekdays, the distribution of ξ is uniform. Hence, three carefully selected standard days can be employed as equi-probable. For the sake of comparison, results for example embodiments are presented for problems composed of two and three scenarios (days). It should be appreciated that such problems are merely for exemplary and purposes only and do not constitute limiting features of the disclosed embodiments.

Because there are some inherent errors in the recording of the data and in the reconstruction of the trips, some data cleaning and filtering were performed to make the data coherent. For example, the observed transfers were filtered to keep only the ones for which the difference between departure and arrival times were larger than the walking time between the stops. Moreover, for each route, only the trips that are common to all days were kept. An alternative would be to consider the number of trips of a route per day as stochastic and add that as an additional random parameter into the disclosed model. The example prototype embodiment contained 369 trip transfers to optimize.

Note that the aforementioned example validation embodiment was implemented in the context of a prototype in python and the open-source solver Cbc was employed to solve the optimization problem. It can be appreciated, however, that the use of python and Cbc are not limiting features of the disclosed embodiments, but are referred to herein for exemplary and edification purposes only.

The preliminary experiments were accomplished for different settings of the time shift bounds and the trip window. The results are reported in Table 1, where the columns represent: the instance characteristics (number of scenarios considered, size of the trip window, offset upper bound—the lower bound is taken as minus the upper bound here); resulting problem size (in terms of number of continuous and binary variables and constraints); the solution quality (the obtained optimal waiting time, the initial waiting time before the optimization, and the reduction achieved by the optimization), and the running time of the program.

TABLE 1
Results of the stochastic schedule optimization of a subset of the transport system of Nancy.

| Instance characteristics | | | Problem size | | | Solution | | | Time |
|---|---|---|---|---|---|---|---|---|---|
| Scenarios | Trip window | Offset bound | Cont var | Bin var | Constr | Opt | Init | Reduc (%) | Time (s) |
| 2 | 0 | 5 | 1226 | 738 | 1725 | 692.5 | 1,325.0 | 47 | 0.25 |
| 2 | 1 | 5 | 2680 | 2192 | 4633 | 681.5 | 1,325.0 | 48 | 1.74 |
| 2 | 3 | 5 | 5574 | 5086 | 10421 | 627.5 | 1,325.0 | 52 | 3.75 |
| 2 | 5 | 5 | 8430 | 7942 | 16133 | 513.0 | 1,325.0 | 61 | 6.26 |
| 3 | 0 | 5 | 1,595 | 1,107 | 2,599 | 815.0 | 1,421.0 | 42 | 0.43 |
| 3 | 0 | 10 | 1,595 | 1,107 | 2,599 | 631.66 | 1,421.0 | 55 | 0.37 |
| 3 | 0 | 15 | 1,595 | 1,107 | 2,599 | 501.66 | 1,421.0 | 64 | 0.64 |
| 3 | 1 | 5 | 3,785 | 3,297 | 6,979 | 804.66 | 1,421.0 | 43 | 2.25 |
| 3 | 1 | 10 | 3,785 | 3,297 | 6,979 | 605.33 | 1,421.0 | 57 | 2.69 |
| 3 | 1 | 15 | 3,785 | 3,297 | 6,979 | 446.33 | 1,421.0 | 68 | 5.00 |
| 3 | 2 | 5 | 5,960 | 5,472 | 11,329 | 777.99 | 1,421.0 | 45 | 4.90 |
| 3 | 2 | 10 | 5,960 | 5,472 | 11,329 | 584.00 | 1,421.0 | 58 | 10.18 |
| 3 | 2 | 15 | 5,960 | 5,472 | 11,329 | 430.33 | 1,421.0 | 69 | 19.18 |
| 3 | 3 | 5 | 8,114 | 7,626 | 15,637 | 744.0 | 1,421.0 | 47 | 12.62 |
| 3 | 3 | 10 | 8,114 | 7,626 | 15,637 | 551.00 | 1,421.0 | 61 | 14.66 |
| 3 | 3 | 15 | 8,114 | 7,626 | 15,637 | 398.66 | 1,421.0 | 71 | 26.92 |
| 3 | 4 | 5 | 10,250 | 9,762 | 19,909 | 678.00 | 1,421.0 | 52 | 17.97 |
| 3 | 4 | 10 | 10,250 | 9,762 | 19,909 | 480.33 | 1,421.0 | 66 | 30.20 |
| 3 | 4 | 15 | 10,250 | 9,762 | 19,909 | 323.66 | 1,421.0 | 77 | 37.00 |
| 3 | 5 | 5 | 12,368 | 11,880 | 24,145 | 658.66 | 1,421.0 | 53 | 19.46 |
| 3 | 5 | 10 | 12,368 | 11,880 | 24,145 | 479.33 | 1,421.0 | 66 | 33.88 |
| 3 | 5 | 15 | 12,401 | 11,913 | 24,211 | 338.66 | 1,421.0 | 76 | 45.45 |

The following observations can be made from the Table 1. First, for all the values of the instance characteristics, a dramatic decrease of the expected waiting time (at least 42% and up to 77%) is observed. Comparing the results for 2 and 3 scenarios, it can be seen that the problem is easier for the case of 2 scenarios: for a given offset bound and trip window, we obtain a better reduction of the waiting time with 2 than 3 scenarios. In fact, it is easy to show that the more scenarios considered, the smaller the feasible space and therefore the smaller the reduction of the waiting times. Thus intuitively, the large improvement that we observe in our simple setting is a good sign that we could obtain a significant improvement even in a more complex setting.

Note that for a fixed bound, when the trip window is nonzero, the problem is larger and takes more time to be solved, but the optimal solution is always better. It can be appreciated that for a fixed bound, the larger the trip window, the better the solution. Similarly, for a fixed time window, the larger the bound on the offset, the better the solution. This is coherent with the definition of the problem (larger feasible space implies potentially better solution). The bound and the trip window play a very different role though. The bound can be imposed by the service operator to limit the modifications of the schedule, whereas the trip window is purely a modeling trick to make the problem smaller. We should take it as large as possible as long as the problem can still be solved in a reasonable time. For a “real-life” application of the disclosed embodiments, commercial solvers such as Cplex or Gurobi could be used. Such solutions are much faster than CBC and would be able to tackle larger problems.

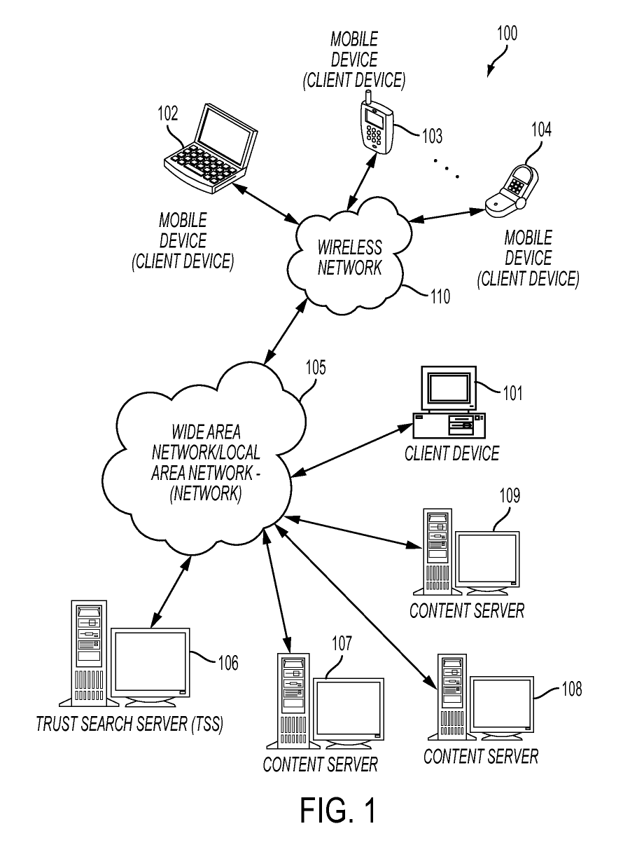

FIG. 1 illustrates a schematic diagram depicting an example embodiment of a system 100 composed of one or more networks. Other embodiments that may vary, for example, in terms of arrangement or in terms of type of components, are also intended to be included within the claimed subject matter. The system 100 depicted in FIG. 1, for example, includes a variety of networks, such as a WAN (Wide Area Network)/LAN (Local Area Network) 105; a wireless network 110; a variety of devices, such as a client device 101, mobile devices 102, 103, 104; a variety of servers, such as content servers 107, 108, 109; and a trust search server 106. In the example configuration depicted in FIG. 1, mobile devices 102, 103, and 104 are client devices that communicate wirelessly with system 100 through the wireless network 110. The WAN/LAN network 105 also communicates with the wireless network 110.

A content server such as content servers 107, 108, 109 may include a device that includes a configuration to provide content via a network to another device. A content server may, for example, host a site, such as a social networking site, examples of which may include, without limitation, Flicker®, Twitter®, Facebook®, LinkedIn®, or a personal user site (e.g., such as a blog, vlog, online dating site, etc.). A content server may also host a variety of other sites, including, but not limited to, business sites, educational sites, dictionary sites, encyclopedia sites, wikis, financial sites, government sites, etc.

A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as a content server include desktop computers, multiprocessor systems, microprocessor-type, or programmable consumer electronics, etc.

A network such as network 105 and/or network 110 depicted in FIG. 1 can couple devices so that communications may be exchanged, such as between a server and a client device or other types of devices, including between wireless devices coupled via a wired or wireless network, for example. A network may also include mass storage, such as network-attached storage (NAS), a storage area network (SAN), or other forms of computer or machine-readable media, for example. A network may include the Internet, one or more local area networks (LANs), one or more wide area networks (WANs), wire-line type connections, wireless type connections, or any combination thereof. Likewise, sub-networks may employ differing architectures or may be compliant or compatible with differing protocols, and may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

A wireless network such as the wireless network 110 depicted in FIG. 1 may couple client devices with the network. That is, such a wireless network may employ stand-alone ad-hoc networks, mesh networks, wireless LAN (WLAN) networks, cellular networks, or the like. A wireless network such as wireless network 110 can further include a system of terminals, gateways, routers, or the like coupled by wireless radio links, or the like, which may move freely, randomly, or organize themselves arbitrarily, such that network topology may change, at times even rapidly. A wireless network may further employ a plurality of network access technologies including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Signal packets communicated via a network, such as a network of participating digital communication networks (e.g., networks 105, 110) may be compatible with or compliant with one or more protocols. The signaling formats or protocols employed may include, for example, TCP/IP, UDP, DECnet. NetBEUI, IPX, AppleTalk, or the like. Versions of the Internet Protocol (IP) may include IPv4 or IPv6.

The internet refers to a decentralized global network of networks. The internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the internet from a user site via an access node coupled to the internet. Likewise, a signal packet may be forwarded via network nodes to a target site coupled to the network via a network access node, for example. A signal packet communicated via the internet may, for example, be routed via a path of gateways, servers, etc., that may route the signal packet in accordance with a target address and availability of a network path to the target address.

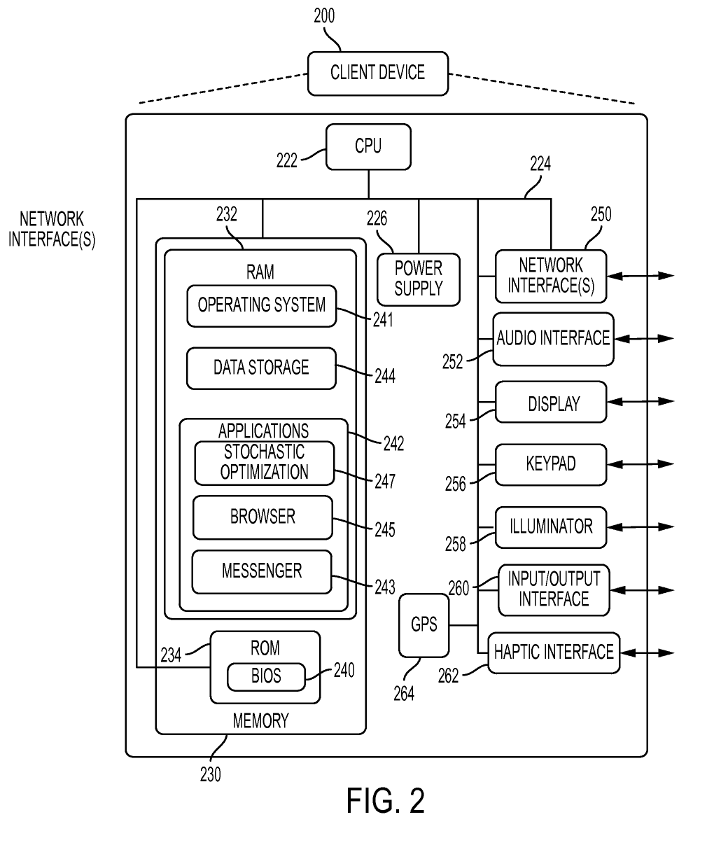

FIG. 2 illustrates a schematic diagram depicting one example embodiment of a client device 200 that may be used as, for example, one or more of the client devices 101, 102, 103, and 104 depicted in FIG. 1. The client device 200 can function as a computing device capable of sending or receiving signals through a wired or a wireless network such as, for example, networks 105, 110 depicted in FIG. 1.

The client device 200 may implemented as, for example, a desktop computer or a portable device, such as a cellular telephone, a Smartphone, a display pager, a radio frequency (RF) device, an infrared (IR) device, a Personal Digital Assistant (PDA), a handheld computer, a tablet computer, a laptop computer, a desktop computer, a set top box, a wearable computer, or an integrated device combining various features, such as features of the forgoing devices, or the like.

A client device such as client device 200 may vary in terms of capabilities or features. The claimed subject matter is intended to cover a wide range of potential variations. For example, a cell phone may include a numeric keypad or a display of limited functionality, such as a monochrome liquid crystal display (LCD) for rendering text and other media. In contrast, however, as another example, a web-enabled client device may include one or more physical or virtual keyboards, mass storage, one or more accelerometers, one or more gyroscopes, global positioning system (GPS) or other location identifying type capability, or a display with a high degree of functionality, such as a touch-sensitive color 2D or 3D display, for example.

A client device such as client device 200 may include or may execute a variety of operating systems, such as operating system 241, including in some example embodiments a personal computer operating system, such as a Windows, iOS or Linux, or a mobile operating system, such as iOS, Android, or Windows Mobile, or the like. A client device such as client device 200 may include or may execute a variety of possible applications, such as a client software application enabling communication with other devices, such as communicating one or more messages, such as via email, short message service (SMS), or multimedia message service (MMS), including via a network, such as a social network, including, for example, Facebook®, LinkedIn®, Twitter®, Flickr®, Google+®, to provide only a few possible examples.

A client device, such as client device 200, may also include or execute an application to communicate content, such as, for example, textual content, multimedia content, or the like. A client device may also include or execute an application to perform a variety of possible tasks, such as browsing, searching, playing various forms of content, including locally stored or streamed video, or games (e.g., fantasy sports leagues, etc.). The foregoing is provided to illustrate that claimed subject matter is intended to include a wide range of possible features or capabilities. Examples of such applications (or modules) can include a messenger 243, a browser 245, and other client application(s) or module(s) such as a stochastic optimization module 247, which can implement instructions or operations such as those described herein.

The example client device 200 shown in FIG. 2 generally includes a CPU (Central Processing Unit) 222 and/or other processors (not shown) coupled electronically via a system bus 224 to memory 230, power supply 226, and a network interface 250. The memory 230 can be composed of RAM (Random Access Memory) 232 and ROM (Read Only Memory) 234. Other example components that may be included with client device 200 can include, for example, an audio interface 252, a display 254, a keypad 256, an illuminator 258, and an input/output interface 260. In some example embodiments, a haptic interface 262 and a GPS (Global Positioning Satellite) unit 264 can also be electronically coupled via the system bus 224 to CPU 222, memory 230, power supply 226, and so on.

RAM 232 can store an operating system 241 and provide for data storage 244, and the storage of applications 242 such as, for example, browser 245 and messenger 243 applications. ROM 234 can include a BIOS (Basic Input/Output System) 240, which is a program that the CPU 222 utilizes to initiate the computing system associated with client device 200. BIOS 240 can also manage data flow between operating system 241 and components such as display 254, keypad 256, and so on.

Applications 242 can thus be stored in memory 230 and may be “loaded” (i.e., transferred from, for example, memory 230 or another memory location) for execution by the client device 200. Client device 200 can receive user commands and data through, for example, the input/output interface 260. The client device 200 in accordance with instructions from operating system 241 and/or application(s) 242 may then act upon such inputs. The interface 260, in some embodiments, can serve to display results, whereupon a user may supply additional inputs or terminate a session.

The following discussion is intended to provide a brief, general description of suitable computing environments in which the disclosed methods and systems may be implemented. Although not required, the disclosed embodiments will be described in the general context of computer-executable instructions, such as program modules being executed by a single computer. In most instances, a “module” constitutes a software application. However, a module may also comprise, for example, electronic and/or computer hardware or such hardware in combination with software. In some cases, a “module” can also constitute a database and/or electronic hardware and software that interact with the database.

Generally, program modules include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term “module” as utilized herein may refer to a collection of routines and data structures that perform a particular task or implement a particular abstract data type. Modules may be composed of two parts: an interface, which lists the constants, data types, variable, and routines that can be accessed by other modules or routines; and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

Thus, the instructions, steps or operations such as those described herein can be implemented in some example embodiments in the context of such a module or a group of modules, sub-modules, and so on. For example, in some embodiments, the applications 242 illustrated in FIG. 2 in the context of client device 200 can function as a module composed of a group of sub-modules such as, for example, the stochastic optimization module 247, browser 245, messenger 243, and so on.

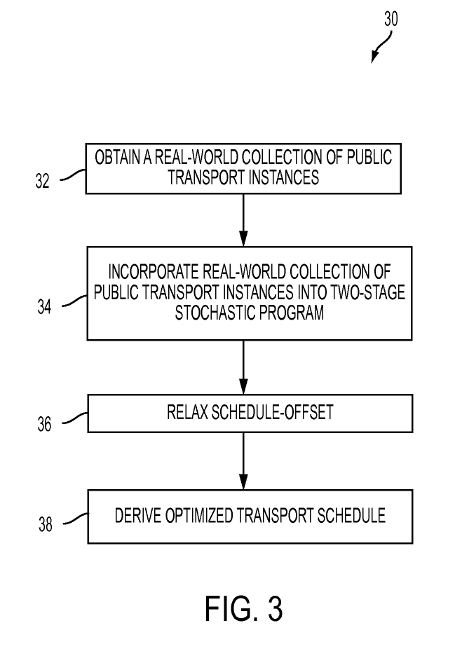

FIG. 3 illustrates a high-level flow chart of operations depicting logical operational steps of a method 30 for the optimization of public transport schedules, in accordance with an example embodiment. As depicted at block 32, an operation can be implemented to obtain a real-world collection of transit instances from a transport system (e.g., a public multi-modal transport system). Then, as indicated at block 34, a step or operation can be implemented to incorporate the real-world collection of transit instances (e.g., real transit events) derived from the transport system into a two-stage stochastic program. Thereafter, as depicted at block 36, a step or operation can be implemented to relax a schedule offset in the two-stage stochastic program to allow the two-stage stochastic program to operate according to the real-world collection of transit instances. Then, as shown at block 38, a step or operation can be implemented to derive an optimized transport schedule from the two-stage stochastic program for use by the transport system based on the schedule offset and the real-world collection of transit instances in order to minimize the waiting times of passengers during transfers via the transport system.

It can be appreciated that the example embodiments illustrated in FIGS. 1-3 serve only as examples to illustrate several ways of implementation of the present disclosure. Such example embodiments should not be construed as to limit the spirit and scope of the example embodiments of the present disclosure. It should be noted that those skilled in the art may still make various modifications or variations without departing from the spirit and scope of the example embodiments. Such modifications and variations shall fall within the protection scope of the example embodiments, as defined in attached claims.

1. A method for minimizing waiting times of passengers during transfers in a transport system, said method comprising:
incorporating a real-world collection of transit instances derived from a transport system into a stochastic optimization module;
relaxing a flexible schedule offset in said stochastic optimization module to allow said stochastic optimization module to operate according to said real-world collection of transit instances; and
deriving an optimized transport schedule from said stochastic optimization module for use by said transport system based on said flexible schedule offset and said real-world collection of transit instances in order to minimize the waiting times of passengers during transfers via said transport system.

2. The method of claim 1 wherein said transport system comprising a multi-modality transportation system.

3. The method of claim 1 wherein said real-world collection of transit instances comprises a collection of available individual transit trips as instances of transfer.

4. The method of claim 1 wherein said optimized transport schedule comprises an altered existing schedule associated with said transport system.

5. The method of claim 1 wherein said stochastic optimization module comprises two stages for treating an uncertainty of arrival times.

6. The method of claim 1 wherein said stochastic optimization module comprises a two-stage stochastic linear program with mixed-integer variables.

7. The method of claim 1 wherein said transport system comprising a multi-modality transportation system and wherein said real-world collection of transit instances comprises a collection of available individual transit trips as instances of transfer.

8. A system for minimizing waiting times of passengers during transfers in a transport system, said system comprising:
at least one processor; and
a computer-usable medium embodying computer program code, said computer-usable medium capable of communicating with said at least one processor, said computer program code comprising instructions executable by said at least one processor and configured for:
incorporating a real-world collection of transit instances derived from a transport system into a stochastic optimization module;
relaxing a flexible schedule offset in said stochastic optimization module to allow said stochastic optimization module to operate according to said real-world collection of transit instances; and
deriving an optimized transport schedule from said stochastic optimization module for use by said transport system based on said flexible schedule offset and said real-world collection of transit instances in order to minimize the waiting times of passengers during transfers via said transport system.

9. The system of claim 8 wherein said transport system comprising a multi-modality transportation system.

10. The system of claim 8 wherein said real-world collection of transit instances comprises a collection of available individual transit trips as instances of transfer.

11. The system of claim 8 wherein said optimized transport schedule comprises an altered existing schedule associated with said transport system.

12. The system of claim 8 wherein said stochastic optimization module comprises two stages for treating an uncertainty of arrival times.

13. The system of claim 8 wherein said stochastic optimization module comprises a two-stage stochastic linear program with mixed-integer variables.

14. The system of claim 13 wherein said transport system comprising a multi-modality transportation system and wherein said real-world collection of transit instances comprises a collection of available individual transit trips as instances of transfer.

15. A processor-readable medium storing code representing instructions to cause a process for minimizing waiting times of passengers during transfers in a transport system, said code comprising code to:
incorporate a real-world collection of transit instances derived from a transport system into a stochastic optimization module:
relax a flexible schedule offset in said stochastic optimization module to allow said stochastic optimization module to operate according to said real-world collection of transit instances: and
derive an optimized transport schedule from said stochastic optimization module for use by said transport system based on said flexible schedule offset and said real-world collection of transit instances in order to minimize the waiting times of passengers during transfers via said transport system.

16. The processor-readable medium of claim 15 wherein said transport system comprising a multi-modality transportation system.

17. The processor-readable medium of claim 15 wherein said real-world collection of transit instances comprises a collection of available individual transit trips as instances of transfer.

18. The processor-readable medium of claim 15 wherein said optimized transport schedule comprises an altered existing schedule associated with said transport system.

19. The processor-readable medium of claim 15 wherein said stochastic optimization module comprises two stages for treating an uncertainty of arrival times.

20. The processor-readable medium of claim 15 wherein said stochastic optimization module comprises a two-stage stochastic linear program with mixed-integer variables.
